(19) United States
(12) Patent Application Publication
(10) Pub. No.: US 2013/0097483 A1
(43) Pub. Date: Apr. 18, 2013

(54) INFORMATION PROCESSING APPARATUS, WEB BROWSER CONTROL METHOD, AND STORAGE MEDIUM STORING PROGRAM THEREOF

(71) Applicant: Nobushige Aoki, Tokyo (JP)

(72) Inventor: Nobushige Aoki, Tokyo (JP)

(73) Assignee: CANON KABUSHIKI KAISHA, Tokyo (JP)

(21) Appl. No.: 13/704,512

(22) PCT Filed: Jun. 22, 2011
(86) PCT No.: PCT/JP2011/064855

§ 371 Date: Dec. 14, 2012

(30) Foreign Application Priority Data
Jul. 16, 2010 (JP) 2010-162213

(51) Int. Cl. G06F 17/22

(52) U.S. Cl. CPC G06F 17/2247
USPC 715/234

(57) ABSTRACT

This invention causes the Web browser to display a tool for processing the acquired Web page, which is called by the Web browser by causing the Web browser to analyze a structured document including a description for calling the tool, and the acquired Web page, and processes the acquired Web page in accordance with operation via the tool.

### TECHNICAL FIELD

The present invention relates to an information processing apparatus which processes Web pages, a Web browser control method for the apparatus, and a storage medium storing a program for the method.

### BACKGROUND ART

It is common practice to acquire various kinds of information by accessing Web pages on the Internet. Web pages include structured documents written in a structured language such as HTML (Hyper Text Markup Language) or XHTML (Extensible Hyper Text Markup Language). Web browser software displays a Web page on a display. A printer prints out the Web page.

Adding an expansion program called a plugin to such a browser can display structured documents and files which cannot initially be displayed by the browser. A plugin for expanding a file into a file which can be displayed by a browser will be referred to as a content expansion plugin hereinafter.

Plugins for the browser also include plugins for printing. Using the plugins for printing can add rich expanded functions such as a printing function to the browser (see Japanese Patent Laid-Open No. 2002-055801). Plugins for expanding the function of the browser, such as the plugin for printing, will be referred to as browser expansion plugins hereinafter.

A browser expansion plugin is executed concurrently with the activation of the browser to expand the function of the browser by displaying a user interface such as a toolbar on the browser. In contrast, a content expansion plugin is executed only when the browser displays a specific structured document or file.

Some browsers, however, do not support browser expansion plugins. Such a browser cannot use any browser expansion plugins for providing rich expanded functions. Even some browsers which support browser expansion plugins are greatly limited in terms of operation, for example, being allowed to execute only script codes.

In the above cases, it is difficult to provide rich expanded functions on various types of browsers.

### SUMMARY OF INVENTION

An aspect of the present invention is to eliminate the above-mentioned problems with conventional technology. The present invention provides an information processing apparatus which easily implements various kinds of expanded functions on a browser, a Web browser control method for the apparatus, and a storage medium storing a program for the method.

The present invention in its first aspect provides an information processing apparatus including a Web browser which displays an acquired Web page, the apparatus comprising: analysis means for analyzing a structured document including a description for calling a tool for processing the acquired Web page, by using the Web browser; display control means for causing the Web browser to display the tool called by the Web browser and the acquired Web page according to the analysis; and processing means for processing the acquired Web page according to operation via the tool.

The present invention in its second aspect provides a Web browser control method executed in an information processing apparatus including a Web browser which displays an acquired Web page, the method comprising: a display control step of causing the Web browser to display a tool for processing the acquired Web page, which is called by the Web browser by causing the Web browser to analyze a structured document including a description for calling the tool, and the acquired Web page; and a processing step of processing the acquired Web page in accordance via operation of the tool.

The present invention in its third aspect provides a computer-readable storage medium storing a program for causing a computer to execute: a display control step of causing the Web browser to display a tool for processing the acquired Web page, which is called by the Web browser by causing the Web browser to analyze a structured document including a description for calling the tool, and the acquired Web page; and a processing step of processing the acquired Web page in accordance with operation via the tool.

The present invention can easily implement various kinds of expanded functions on a browser.

Further features of the present invention will become apparent from the following description of exemplary embodiments with reference to the attached drawings.

### BRIEF DESCRIPTION OF DRAWINGS

FIG. 1 is a perspective view showing the arrangement of a system including an information processing apparatus;

FIG. 2 is a block diagram showing the internal arrangement of a PC;

FIG. 3 is a block diagram showing the arrangement of software in the first embodiment;

FIG. 4 is a view showing an example of how a browser displays structured document 1;

FIG. 5 is a view showing an example of how the browser displays structured document 2;

FIG. 6 is a view showing an example of structured document 2;

FIG. 7 is a flowchart showing a processing procedure for displaying a print preview;

FIG. 8 is a block diagram showing the arrangement of software in the second embodiment; and

FIG. 9 is a view showing an example of how a browser displays structure document 1 and a selected area rectangle.

### DESCRIPTION OF EMBODIMENTS

The preferred embodiments of the present invention will be described in detail below with reference to the accompanying drawings. The following embodiments do not limit the present invention according to the appended claims, and not all combinations of characteristic features described in the embodiments are essential to the solving means of the present invention. The same reference numerals denote the same constituent elements, and a description of them will be omitted.

### First Embodiment

FIG. 1 is a perspective view showing the arrangement of a system including an information processing apparatus according to an embodiment of the present invention. A PC 101 as an information processing apparatus can download Web pages from a plurality of WWW servers 103 onto the PC 101 via network 102 and display the pages. Web pages include structure documents described in a structured language such as HTML or XHTML. The PC 101 is also connected to a printer 104, and can download Web pages on the WWW servers 103 onto the PC 101 and cause the printer 104 to print out the pages.

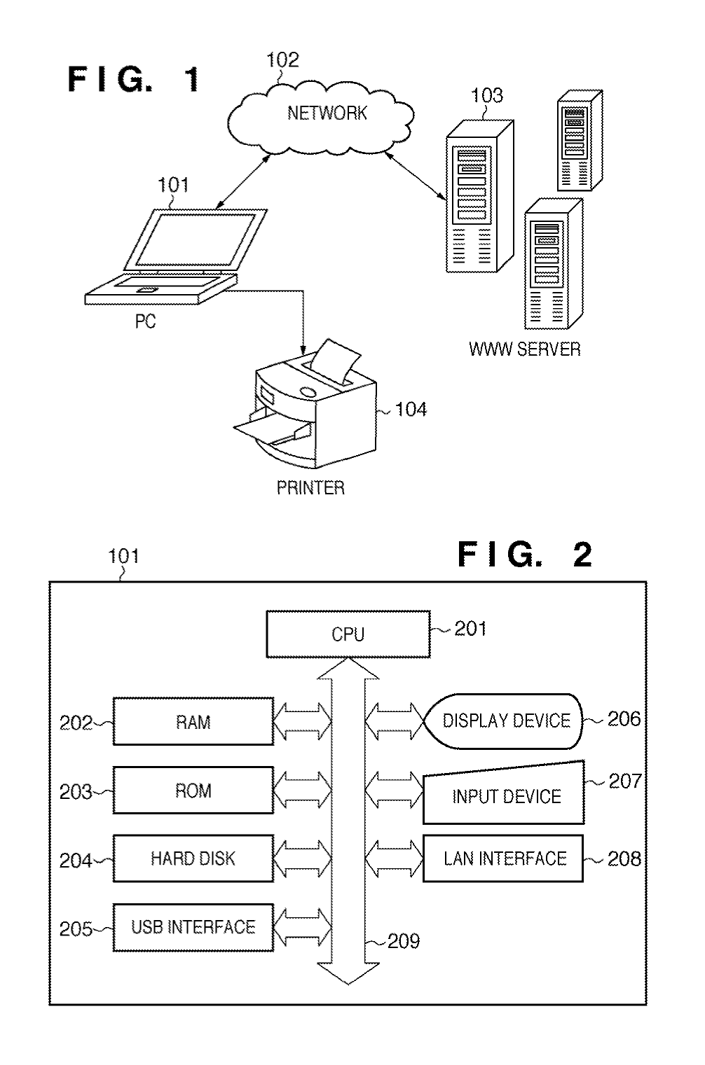

FIG. 2 is a block diagram showing the internal arrangement of the PC 101. A CPU 201 processes data and instructions in accordance with programs stored in a RAM 202, a ROM 203, or a hard disk 204. The RAM 202 is used as a temporary storage area when the CPU 201 performs various kinds of processing. The hard disk 204 stores an operating system (OS), a Web browser (to be referred to as a browser hereinafter), other kinds of application software, and the like. A USB interface 205 is an interface to which a USB cable is connected, and serves as an interface for data communication with the printer 104. Note that it is possible to communicate with the printer 104 via a SCSI or wirelessly instead of the USB cable.

A display device 206 includes a CRT or a liquid crystal display and a graphic controller, and displays a Web page downloaded from the WWW server 103, print preview image, GUI, or the like. An input device 207 is a device which allows the user to issue various kinds of instructions to the PC 101, and is, for example, a pointing device or a keyboard. A system bus 209 connects the CPU 201, the RAM 202, the ROM 203, the hard disk 204, and the like to each other. Data are communicated on the system bus 209. A LAN interface 208 is an interface for connecting the PC 101 to a LAN. The PC 101 performs, via the LAN interface 208, data communication with the external WWW server 103 connected via a router (not shown) and the network 102. Alternatively, a wireless interface may be provided for the PC 101 to perform wireless data communication. In addition, the PC 101 may be a so-called notebook computer integrally incorporating the display device 206 and the input device 207 or a so-called desktop computer including them as discrete units.

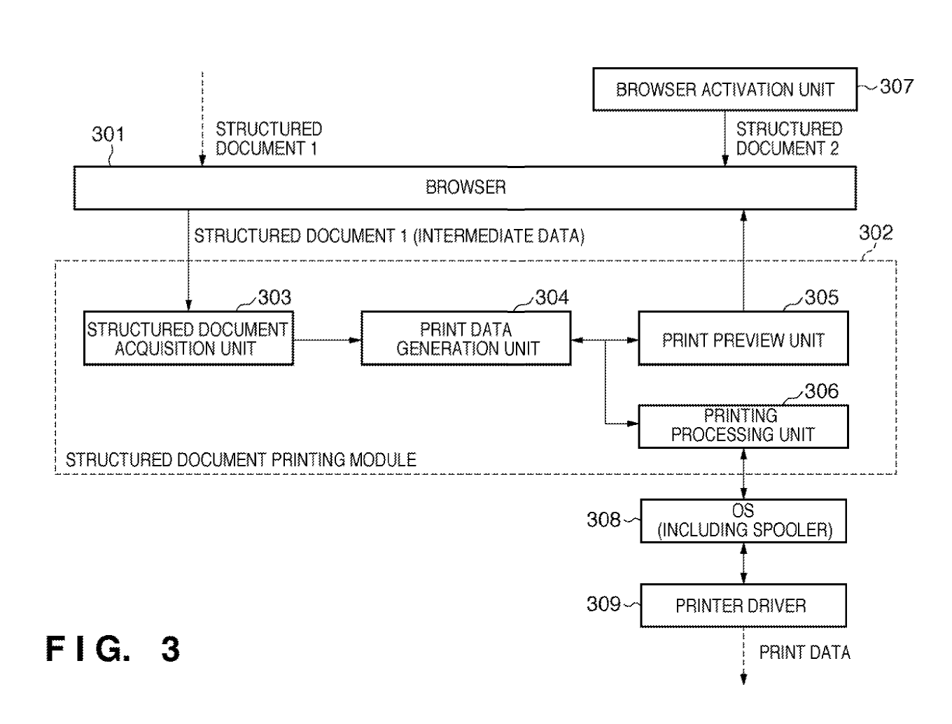

FIG. 3 is a block diagram showing the arrangement of software installed in the PC 101. A browser 301 is an application for displaying Web pages. The browser 301 downloads a Web page (structured document 1) from the WWW server 103 into the hard disk 204 of the PC 101, and displays it on the display device 206. In this case, a structured document is structured document data described in a structured language such as HTML or XHTML, and elements constituting the structured document, such as text or images, are described using tags. Furthermore, another file called a CSS (Cascading Style Sheet) for designating the display styles of these elements is designated in the structured document. The browser 301 displays the structured document on the display device 206 in accordance with the form designated by analyzing the structured document and using tags and the like.

Structured document 2 shown in FIG. 3 is a structured document for allowing the browser 301 to load a structured document printing module 302, and is stored in the hard disk 204 of the PC 101. In addition, structured document 2 includes a description for designating the structured document printing module 302. This description allows the browser 301 to load the structured document printing module 302. The details of structured document 2 will be described later.

A browser activation unit 307 is a program for making the browser 301 display structured document 2 in a display window. In response to an instruction from a user, the browser activation unit 307 reads out structured document 2 from the hard disk 204 of the PC 101, and designates structured document 2. The browser 301 then displays structured document 2 in its own window. With regard to an instruction from the user, for example, information that can specify structured document 2 by using a function such as the “favorites” function that can register URLs and file paths may be registered in the browser 301 in advance, and the user may select structured document 2 by using the function. In this case, it is possible to register information that can specify structured document 2 in the “favorites” function. That is, when the structured document printing module 302 is installed in the PC 101, structured document 2 for calling the structured document printing module is stored in a predetermined location in the hard disk 204. Information indicating this storage location may be automatically registered in the “favorites” function of the browser 301.

The structured document printing module 302 is a content expansion plugin to be called from the browser 301 when the browser 301 interprets the descriptions contained in structured document 2. The structured document printing module 302 allows the displaying of a print preview window including operation instruction buttons and the like for a user interface in a Web page display area of the browser 301. The browser 301 loads and executes the structured document printing module 302, and performs display in the designated area of the window in accordance with structured document 2. A structured document acquisition unit 303 of the structured document printing module 302 acquires structured document 1 converted into intermediate data from the browser 301. In this case, structured document 1 converted into the intermediate data is an archive file obtained by combining a structured document, a CSS file, an image file, and the like into one file. It is possible to use the URL of structured document 1 instead of structured document 1 converted into the intermediate data. It is also possible to use a page description language file such as a PDF (Portable Document Format), XPS (XML Paper Specification), or EMF (Enhanced Metafile) file converted from structured document 1. In these page description language files, it is preferable to express line drawings in a vector format and texts in character codes.

A print data generation unit 304 generates print data by laying out structured document 1 converted into the intermediate data and acquired by the structured document acquisition unit 303 according to the paper size based on print settings. In this case, the layout of structured document 1 is adjusted to prevent any element included in structured document 1 from protruding from the sheet and being omitted or prevent a specific element such as an image from being printed over a plurality of sheets. The print settings include a paper size, resolution, and printable area. The structured document printing module 302 acquires these print settings from a printer driver 309 for the printer 104 via an OS 308. In this case, print data is, for example, a PDF file, but may be data in another page description language such as XPS or EMF.

A print preview unit 305 generates print preview data including the print data generated by the print data generation unit 304 and operation instruction buttons for a user interface. The print preview unit 305 displays the print preview in the Web page display area of the browser 301 based on the print preview data. Upon receiving a printing start instruction from the user, a printing processing unit 306 performs rendering in accordance with the print data generated by the print data generation unit 304, and issues an instruction to issue a print command to the printer driver 309 via the OS 308.

The OS 308 provides an API for allowing the structured document printing module 302 and the printer driver 309 to transmit/receive print setting data or perform rendering. The OS 308 includes various kinds of control software such as a spooler for managing print jobs and a port monitor for outputting a print command to a port. The details of the control software will not be described later. The printer driver 309 generates a print command in accordance with the rendering executed by the printing processing unit 306, and transmits the print command to the printer 104. Upon receiving the print command, the printer 104 generates print image data based on the rendered print data, and prints an image based on the image data on a sheet.

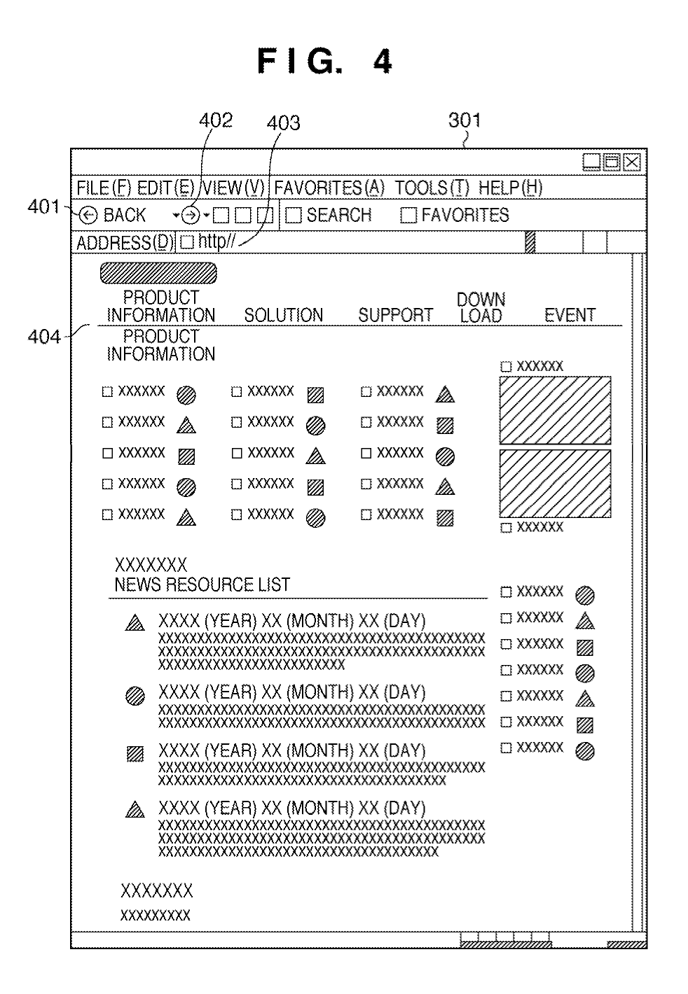

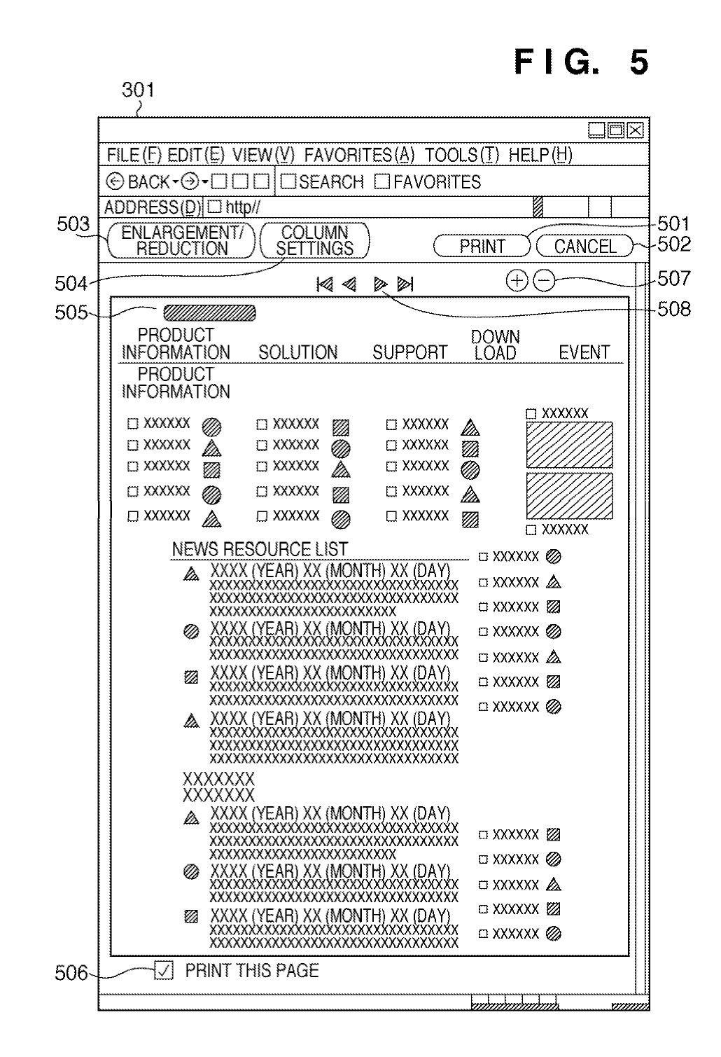

FIGS. 4 and 5 each show an example of a GUI window displayed by the browser 301 on the PC 101 in this embodiment. As shown in FIG. 4, the browser 301 includes a back button 401 for switching to the Web page displayed immediately before the current window, a button 402 for moving forward to the initial Web page after switching back with the back button 401, an address input area 403 into which an URL is input, and a Web page display area 404 in which a Web page is displayed. When the user inputs the URL of structured document 1 as a Web page into the address input area 403 and issues an access instruction, the browser 301 acquires structured document 1 in accordance with the URL via the WWW server 103. The browser 301 then analyzes acquired structured document 1, and displays the result obtained by analyzing structured document 1 in the Web page display area 404, as shown in FIG. 4.

FIG. 5 shows an example of how the browser 301 performs display in accordance with structured document 2. Upon designation of the URL of structured document 2 by the user, the browser 301 calls structured document 2 and analyzes the contents of structured document 2. The browser 301 reads out the structured document printing module 302 complying with the descriptions of structured document 2 from the hard disk 204 of the PC 101 upon analysis of structured document 2, and displays the structured document printing module 302 in the Web page display area 404 of the browser 301. In addition, the structured document printing module 302 displays a print preview of structured document 1 in the Web page display area 404. That is, in this embodiment, the structured document printing module 302 can display a framework for the display of the print preview in the Web page display area 404. The structured document printing module 302 can embed structured document 1 in the framework and display the resultant image as a print preview. The framework for the display of the print preview is displayed, including a print preview display 505 indicating structured document 1 printed with the current print settings, a printing button 501 for issuing a print instruction, a cancel button 502 for stopping print preview display, an enlargement/reduction button 503 for enlarging or reducing print preview display, various kinds of buttons 508 for page switching which are used to switch pages to be displayed, a multicolumn printing button 504 for designating a multicolumn layout, and a check box 506 for print target page designation which is used to designate a print target page. Data for displaying these various kinds of operation designation buttons will be specifically referred to as designation button display data. Note that designation button display data to be used need not be limited to them, and may include data other than them. In addition, designation button display data need not be data for printing, and may be used for various kinds of expanded functions such as a Web page editing function.

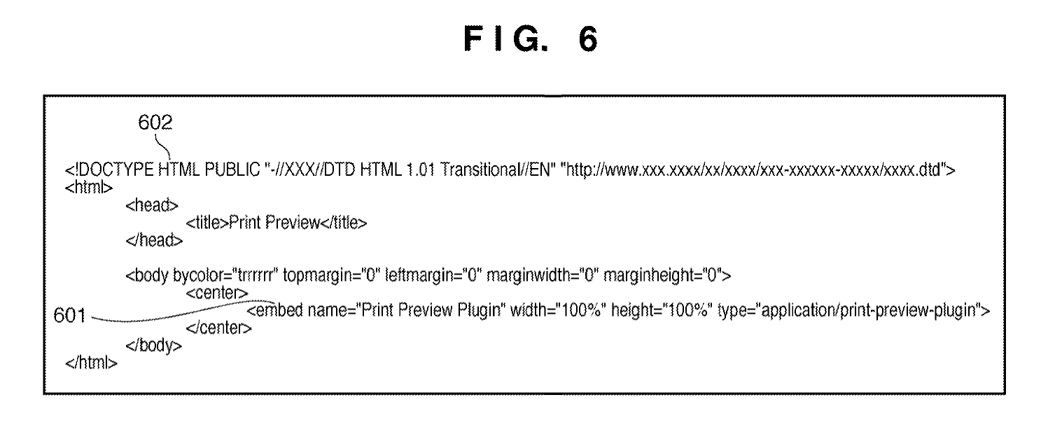

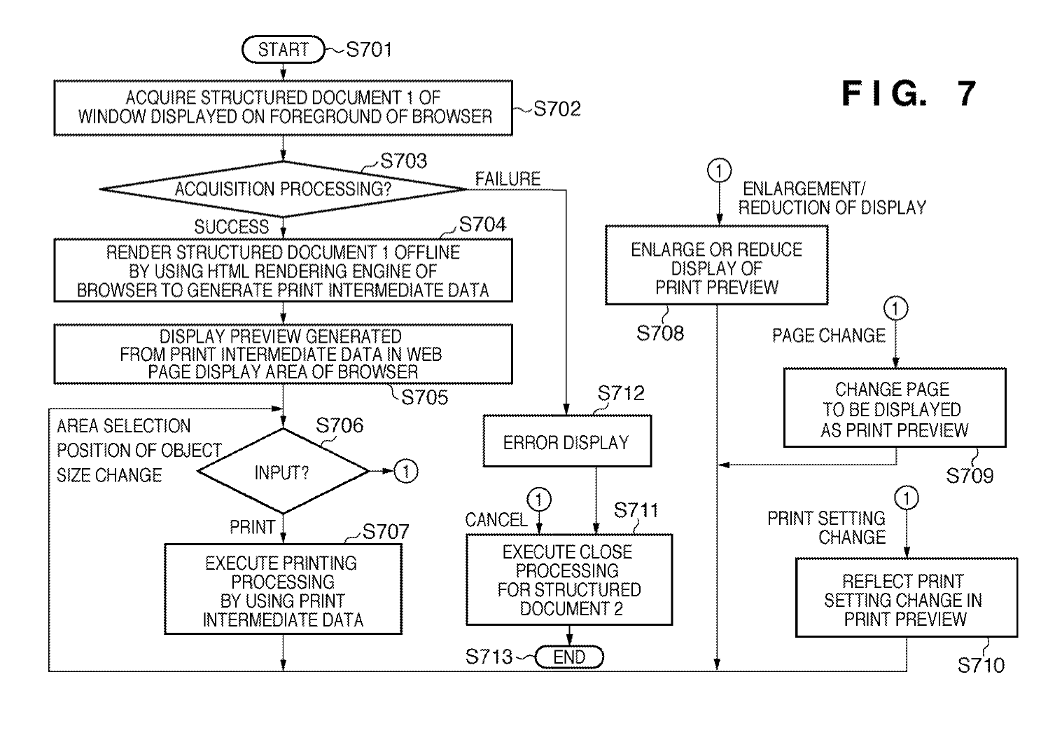

FIG. 6 is a view showing an example of structured document 2 in this embodiment. As shown in FIG. 6, structured document 2 is described in a structured language in the HTML format. Structured document 2 describes an <embed> tag 601 for designating the structured document printing module 302. The browser 301 reads out the structured document printing module 302 from the hard disk 204 of the PC 101 by referring to the <embed> tag 601, and displays the module in the Web page display area 404 of the browser 301.

FIG. 7 is a flowchart showing a procedure for Web browser control processing in which the browser 301 loads the structured document printing module 302 to display a print preview. For example, when the window shown in FIG. 4 is displayed, the user issues an instruction to display a print preview window from the menu on the display window on the PC 101. In response to this instruction, the processing shown in FIG. 7 is executed. The CPU 201 executes the processing shown in FIG. 7 (the program of the structured document printing module 302).

First of all, in response to an instruction from the user, the browser 301 reads out structured document 2 and parses it to specify that the structured document printing module is designated by the <embed> tag of structured document 2. The browser 301 activates the designated structured document printing module 302 (S701). In step S702, the structured document acquisition unit 303 retrieves one of the windows displayed by the browser 301 which is displayed on the foreground, and acquires structured document 1, displayed in the window, in an intermediate data format. In step S703, if the structured document acquisition unit 303 has succeeded in acquiring structured document 1 converted into the intermediate data, the process advances to step S704. If the structured document acquisition unit 303 has failed in acquiring structured document 1 converted into the intermediate data, the browser 301 displays an error window in step S712. The process then advances to step S711. In step S704, the print data generation unit 304 generates print intermediate data by rendering structured document 1 in the intermediate data format acquired in step S702 in a predetermined area in the RAM 202 by using the HTML rendering engine (parser) of the browser 301. In step S705, the print preview unit 305 displays a print preview in the Web page display area 404 of the browser 301 by using the print intermediate data. The operation to be performed to display the print preview is the same as that described with reference to the print preview unit 305.

In step S706, the process waits until the user performs input operation using a pointing device or the like. In this case, when the user presses the printing button 501, the process advances to step S707. When the user presses the enlargement/reduction button 503 for display, the process advances to step S708. When the user presses the buttons 508 for page change such as page feeding, the process advances to step S709. When the user changes a printing setting by pressing the multicolumn printing button 504, the process advances to step S710. When the user presses the cancel button 502, the process advances to step S711.

In step S707, the printing processing unit 306 renders print intermediate data by using a render instruction, and issues a print command to the printer driver 309 via the OS 308. When the printer driver 309 outputs the print command to the printer 104, the printer 104 executes printing processing. In steps S708 and S709, the browser 301 changes the display magnification or page of the print preview displayed by the print preview unit 305 to update the display of the Web page display area 404 by the browser 301. In step S710, the print preview unit 305 notifies the print data generation unit 304 of the changed print settings, and the print data generation unit 304 generates print intermediate data with the updated print settings again. The print preview unit 305 displays the Web page display area 404 based on the generated print intermediate data. In step S711, the browser 301 executes close processing for structured document 2. That is, the browser 301 executes close processing for the window displaying structured document 2. In step S713, the browser 301 terminates the structured document printing module 302. With the above procedure, the structured document printing module 302 displays the print preview in the Web page display area 404 of the browser 301, and executes printing processing for the printer 104.

In this embodiment, even a browser which does not support a browser expansion plugin can display a print preview window having rich operation functions in the Web page display area of the browser by using a content expansion plugin.

In this embodiment, the structured document acquisition unit 303 retrieves one of the windows displayed by the browser 301 which is displayed on the foreground, and acquires structured document 1, displayed in the window, in an intermediate data format. However, it is possible to acquire the URL of structured document 1 displayed previously from the display history of the browser and acquire the intermediate data of structured document 1. In this embodiment, as shown in FIGS. 4 and 5, a print preview window is displayed in the Web page display area of a window different from the window of the browser in which a Web page is displayed. However, it is possible to display a print preview window upon switching from a Web page displayed in a window of the browser. It is also possible to display a print preview by performing display according to structured document 2, instead of displaying a print preview window after displaying structured document 1, when the URL of structured document 1 is designated and structured document 1 is to be displayed.

In this embodiment, the hard disk 204 of the PC 101 stores structured document 2 for the execution of the structured document printing module 302. However, the external WWW server 103 may store structured document 2. In this case, a program in the WWW server 103 may dynamically generate structured document 2.

This embodiment executes structured document 2 by using an HTML file. It is, however, possible to execute structured document 2 by using a script or the like. That is, when the structured document printing module 302 is installed in the PC 101, the hard disk 204 stores an application having script commands including the description of structured document 2 and various kinds of modules for expanded functions. When acquiring a Web page as a processing target and calling this application, the browser 301 analyzes the contents of structured document 2 included in the application. The subsequent processing is the same as that described above.

### Second Embodiment

A system arrangement and the arrangement of a PC according to this embodiment are the same as those described with reference to FIGS. 1 and 2. In addition, a processing procedure is the same as that in the first embodiment except for the following processing.

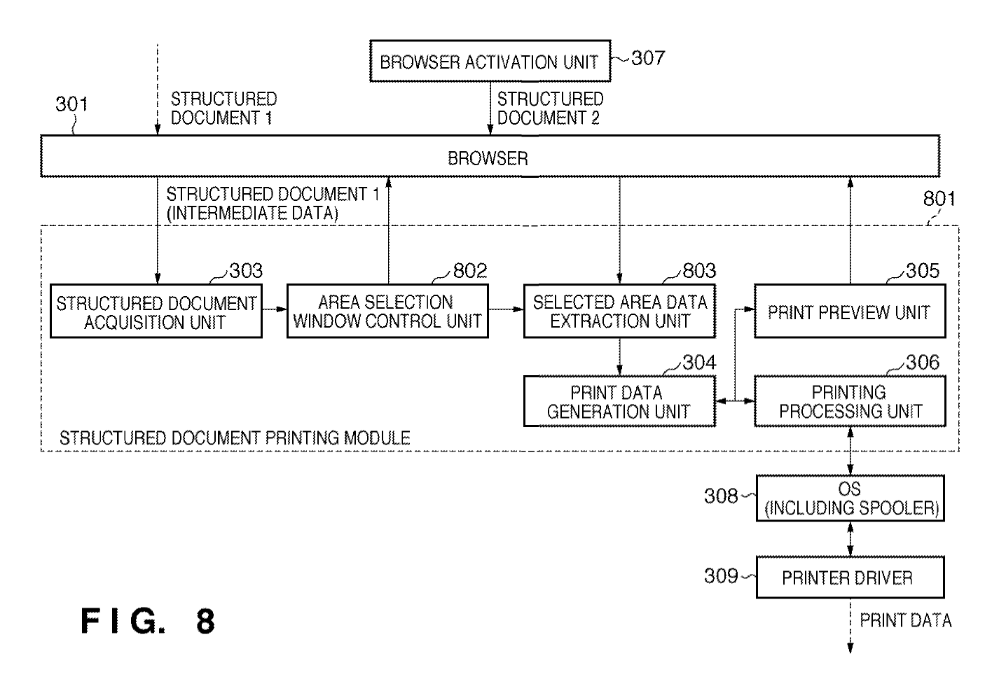

FIG. 8 is a block diagram showing the arrangement of software implemented in a PC 101 in this embodiment. A browser 301, structured document 1, structured document 2, and a browser activation unit 307 shown in FIG. 8 are the same as those described with reference to FIG. 3.

A structured document printing module 801 shown in FIG. 8 is a content expansion plugin called from the browser 301 according to the designation described in structured document 2. The structured document printing module 801 according to this embodiment can select and print a Web page for an arbitrary rectangular area selected by the user on structured document 1.

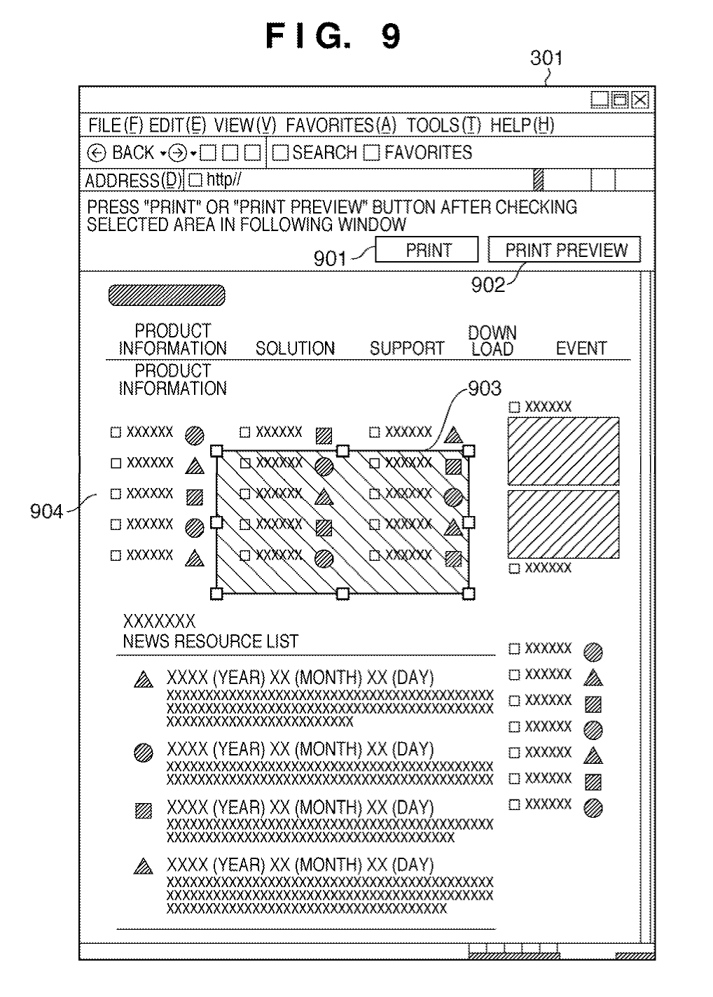

As in the first embodiment, a structured document acquisition unit 303 acquires structured document 1 in the form of converted intermediate data from the browser 301. Thereafter, an area selection window control unit 802 causes the browser 301 to display structured document 1 and a selected area rectangular frame in a display window. The selected area rectangular frame is displayed to allow the user to change its size and position. FIG. 9 is a view showing an example of a GUI window displaying structured document 1 and a selected area rectangle 903 in the display window generated by the browser 301. The details of the GUI window will be described later. The user can designate an arbitrary rectangular area on structured document 1 as a selected area by using an input device 207 such as a pointing device.

After the user selects an area in structured document 1, when he/she issues an instruction to start printing the area as a target or displaying a print preview, a selected area data extraction unit 803 executes processing. The selected area data extraction unit 803 acquires the coordinates of a rectangle set by the selected area rectangle 903, and extracts part of the structured document (intermediate data) included in the rectangular area as intermediate data. The print data generation unit 304 generates print intermediate data (to be also referred to as print data) by laying out the intermediate data extracted by the selected area data extraction unit 803 in a paper size according to print settings. A print preview unit 305, a printing processing unit 306, an OS 308, and a printer driver 309 are the same as those described with reference to FIG. 3.

FIG. 9 is a view showing an example of a GUI window displaying structured document 1 and the selected area rectangle 903 in the display window generated by the browser 301. Structured document 1 and the translucent selected area rectangle 903 are rendered in the Web page display area 404 of the browser 301. The user can drag the selected area rectangle 903 or change its size by using the input device 207 such as a pointing device, and can designate an arbitrary rectangular area on structured document 1. A printing button 901 and a print preview button 902 are buttons for issuing instructions to perform printing processing and print preview display processing for the selected area rectangle 903 as a target.

As described above, in this embodiment, even a browser which does not support a browser expansion plugin can display a window for the selection of an arbitrary area of a structured document in the Web page display area of the browser by using a content expansion plugin. In addition, it is possible to perform printing and display a print preview for the selected area as a target. This embodiment executes printing for a selected area as a target, but can store a selected area as an image file.

Although the above embodiment has exemplified the case in which the printing function of a Web page is expanded as an expanded function for Web page processing, functions other than the printing function may be expanded. That is, it is possible to expand a Web page editing function (the function of processing an acquired Web page and storing it) or the like. In this case, a Web page as an editing target and tools (buttons and the like) for the expanded function (editing) are displayed in the Web page display area 404 of the browser 301.

In addition, in the above case, an acquired Web page converted into data in another format such as intermediate data and tools for an expanded function are displayed. However, it is possible to display an acquired Web page itself and tools for an expanded function.

Furthermore, although a Web page used for printing and editing has been described as a structured document, it is possible to apply the embodiment to various kinds of formats as long as Web pages are in formats that can be processed by the browser 301.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-162213, filed Jul. 16, 2010, which is hereby incorporated by reference herein in its entirety.

1. An information processing apparatus including a Web browser which displays an acquired Web page, the apparatus comprising:
an analysis unit configured to analyze a structured document including a description for calling a tool for processing the acquired Web page, by using said Web browser;
a display control unit configured to cause said Web browser to display the tool called by the Web browser and the acquired Web page according to the analysis; and
a processing unit configured to process the acquired Web page according to operation via the tool.

2. The apparatus according to claim 1, further comprising a generation unit configured to generate print data based on the acquired Web page,
wherein said processing unit causes a printing apparatus to print the print data generated based on the acquired Web page in accordance with the operation via the tool.

3. The apparatus according to claim 1, wherein said processing unit edits the acquired Web page in accordance with the operation via the tool.

4. The apparatus according to claim 1, wherein the structured document is acquired by a favorites function of said Web browser.

5. The apparatus according to claim 1, wherein the structured document is acquired by a script included in a predetermined application.

6. A Web browser control method executed in an information processing apparatus including a Web browser which displays an acquired Web page, the method comprising:
a display control step of causing the Web browser to display a tool for processing the acquired Web page, which is called by the Web browser by causing the Web browser to analyze a structured document including a description for calling the tool, and the acquired Web page; and
a processing step of processing the acquired Web page in accordance via operation of the tool.

7. A computer-readable storage medium storing a program for causing a computer to execute:
a display control step of causing the Web browser to display a tool for processing the acquired Web page, which is called by the Web browser by causing the Web browser to analyze a structured document including a description for calling the tool, and the acquired Web page; and
a processing step of processing the acquired Web page in accordance with operation via the tool.
